(19) United States
(12) Patent Application Publication
(10) Pub. No.: US 2017/0094981 A1
(43) Pub. Date: Apr. 6, 2017

(54) GRAIN-FREE FLOUR BLEND AND METHOD FOR MAKING THE SAME

(71) Applicant: Deborah Lapatina, Ranchos de Taos, NM (US)

(72) Inventor: Deborah Lapatina, Ranchos de Taos, NM (US)

(21) Appl. No.: 14/876,707

(22) Filed: Oct. 6, 2015

(51) Int. Cl. A21D 13/06; A21D 2/36

(52) U.S. Cl. CPC A21D 13/066; A21D 2/36

(57) ABSTRACT

The present invention comprises a grain-free flour blend comprising at least one ingredient from each of the following groups: the group comprising nut and/or seed flour; the group comprising arrowroot powder and/or potato starch; and the group comprising gum and/or hydrocolloid. Furthermore, the present invention comprises a method for producing a grain-free flour blend, the method comprising providing at least one ingredient from each of the following groups: the group comprising nut and/or seed flour; the group comprising arrowroot powder and/or potato starch; and the group comprising gum and/or hydrocolloid.

### CROSS-REFERENCE TO RELATED APPLICATION

This application claims the benefit of U.S. Provisional Patent Application Ser. No. 62/060,383 filed Oct. 6, 2014, titled “GRAIN-FREE FLOUR BLEND AND METHOD FOR MAKING THE SAME” and the subject matter thereof is incorporated herein by reference thereto.

### TECHNICAL FIELD

The present invention is directed to novel grain-free flour blends and methods of producing same.

### BACKGROUND ART

Gluten is a protein composite found in wheat and related grains. Gluten has historically been important in cooking because it gives elasticity to dough, helping it to rise and keep its shape, and can give the final product a chewy texture. However, in individuals with coeliac disease, an autoimmune disorder, consumption of gluten causes adverse health issues, including, but not limited to: abdominal bloating, gas, vomiting, diarrhea, migraines, and joint pain. While there is no known cure for coeliac disease, it is manageable with a gluten-free diet. Additionally, some people also have a wheat allergy and some people, for various medical reasons, follow a gluten-free diet.

Unfortunately, many gluten-free foods simply do not taste as good as their gluten counterparts. In gluten-free baking, people often complain about the taste resulting from the gluten substitute that is being used. In the absence of gluten, one needs some other binding agent, which oftentimes do not impart a pleasant taste into the food.

Therefore, many people for any number of reasons are looking for gluten-free foods that offer a pleasant taste. The present invention provides a gluten-free, grain-free flour blend and method for making the same.

The prior art contains various products that are gluten-free with differing ingredients. U.S. 20090092716 A1 entitled “Gluten-Free Baked Products and Methods of Preparations of Same” claims a gluten-free composition.

U.S. Pat. No. 8,685,482 B2 entitled “Gluten-Free Food Compositions Comprising Cheese, Starch, and Gluten-Free Flour and Method for Making the Same” claims a composition that includes a cheese.

U.S. 20090136642 A1 entitled “Flour Formulations for Making Gluten-Free Food Products” claims a formulation that includes root.

Many of the prior art formulations do not offer the desired texture, consistency, and baking abilities. Furthermore, the prior art formulations are not grain-free formulations and they do not deliver a superior baked good with a taste, ‘gluten-like’ texture, and mouth feel that very closely matches traditional wheat flour baked goods.

The present invention addresses the need for a good tasting and bake-able flour that is grain free, and in-turn naturally gluten-free

The present invention is gluten-free but does not contain rice, corn, soy, sorghum, bean, amaranth, and/or teff which are most commonly found in gluten-free flours. The present invention, when used as a traditional flour substitute, provides a taste and texture that closely mimics traditional wheat-based goods, along with higher vitamin/fiber content with lower glycemic index than most gluten-free products.

### SUMMARY OF THE INVENTION

The present invention comprises a grain-free flour blend comprising at least one ingredient from each of the following groups: the group comprising nut and/or seed flour; the group comprising arrowroot powder and/or potato starch; and the group comprising gum and/or hydrocolloid. Furthermore, the present invention comprises a method for producing a grain-free flour blend, the method comprising providing at least one ingredient from each of the following groups: the group comprising nut and/or seed flour; the group comprising arrowroot powder and/or potato starch; and the group comprising gum and/or hydrocolloid.

### DETAILED DESCRIPTION OF THE INVENTION

Certain embodiments of the invention have other steps or elements in addition to or in place of those mentioned above. The steps or element will become apparent to those skilled in the art from a reading of the following detailed description.

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

The present invention comprises a grain-free flour blend and method for making the same. The grain-free flour blend of the present invention comprises ingredients taken from each of the following groups: the group comprising nut and/or seed flour; the group comprising arrowroot powder and/or potato starch; and the group comprising gum and/or hydrocolloid. A plurality of ingredients, with at least one from each group, are combined.

Nut and/or seed flour is chosen from the following, including, but not limited to: flax seed, millet seed, sunflower seed, chia seed, buckwheat, pumpkin seed, chestnut, mesquite, jackfruit, pecans, walnuts, hazelnuts, cashews, peanuts, plantain, yam, almond meal, coconut, and cassava (tapioca). A plurality of the nut and/or seed flours is used in the present invention.

The group comprising arrowroot powder and/or potato starch is chosen from the following, including, but not limited to: tapioca, arrowroot, potato, gelatin, and ascorbic acid. A plurality of the items from this group are used in the present invention

Gum and/or hydrocolloid is chosen from the following, including, but not limited to: guar, xanthan, tara, and cellulose, as well as gum blends, including, but not limited to: HydroFi-123. A plurality of the items from this group are used in the present invention.

In one embodiment of the present invention, the following ingredients are used, with percentages by volume given: xanthan gum 1.10%; coconut flour 6.08%; golden flax 6.63%; cassava flour 21.0%; almond meal 16.6%; millet flour 24.9%; arrowroot powder 23.8%. All percentages given are approximate. In one embodiment of the present invention, the following ingredients are used, with percentages by volume given: xanthan gum 2.05%; coconut flour 4.10%; flax meal 3.08%; potato starch 20.5%; almond meal 15.4%; millet flour 24.6%; arrowroot powder 30.3%. All percentages given are approximate.

In alternate embodiments of the present invention, a plurality of ingredients from the group comprising a nut and/or seed flour, the group comprising arrowroot powder and/or potato starch, and the group comprising xanthan gum and/or hydrocolloid, with at least one ingredient from each group chosen, are combined.

The present invention further provides a method for producing the grain-free flour blend of the present invention by providing at least one ingredient from each of the following groups: the group comprising nut and/or seed flour; the group comprising arrowroot powder and/or potato starch; and the group comprising gum and/or hydrocolloid

The grain-free flour of the present invention is used for, including, not limited to: baking, breading or dredging, boiling, and frying.

An improvement of the present invention is that it, when used as a traditional flour substitute, provides a taste and texture that closely mimics traditional wheat-based goods, along with higher vitamin/fiber content with lower glycemic index than most gluten-free products.

Another improvement of the present invention is that it addresses the need for a good tasting and bake-able flour that is grain free, and in-turn naturally gluten-free.

While the present invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein are to be interpreted in an illustrative and non-limiting sense.

What is claimed is:

1. A grain-free flour blend comprising at least one ingredient from each of the following groups:
the group comprising nut and/or seed flour;
the group comprising arrowroot powder and/or potato starch; and
the group comprising gum and/or hydrocolloid.

2. A method for producing a grain-free flour blend, the method comprising providing at least one ingredient from each of the following groups:
the group comprising nut and/or seed flour;
the group comprising arrowroot powder and/or potato starch; and
the group comprising gum and/or hydrocolloid.
